(19) United States
(12) Patent Application Publication
(10) Pub. No.: US 2012/0225248 A1
(43) Pub. Date: Sep. 6, 2012

(54) ARTIFICIAL LEATHER HAVING COMPOSITE FIBER AND METHOD FOR MAKING THE SAME

(75) Inventors: LUNG-CHUAN WANG, Kaohsiung City (TW); CHUNG-CHIH FENG, Kaohsiung City (TW); JUNG-CHING CHANG, Kaohsiung City (TW); HSIEN-CHANG HUNG, Kaohsiung City (TW); CHIEN-TE WU, Kaohsiung City (TW); TI-SHUN YEH, Kaohsiung City (TW)

(73) Assignee: SAN FANG CHEMICAL INDUSTRY CO., LTD., Kaohsiung City (TW)

(21) Appl. No.: 13/401,635

(22) Filed: Feb. 21, 2012

(30) Foreign Application Priority Data
Mar. 3, 2011 (TW) 100107017

(51) Int. Cl. B32B 38/04; D06N 3/00; D06N 3/14; D06N 3/10; D06N 3/12; D04H 13/00; D06N 3/06

(52) U.S. Cl. 428/151; 156/148; 156/280

(57) ABSTRACT

The present invention relates to an artificial leather having composite fibers and a method for making the same. The artificial leather includes a substrate and a flexible film. The substrate includes a plurality of composite fibers. Each composite fiber includes a first composition and a second composition. The first composition is a thermoplastic non-elastomer, and the second composition is a thermoplastic elastomer. The second composition accounts for 5% to 70% of the total weight of the composite fiber. The second composition at the intersecting points between the composite fibers is molten to form a flexible bonding point.

The flexible film is located on a surface of the substrate, and the material of the flexible film is an elastic polymer or a latex. Therefore, the artificial leather has excellent textile sensation and physical properties.

### BACKGROUND OF THE INVENTION

1. Field of the Invention

The present invention relates to an artificial leather and a method for making the same, and more particularly to an artificial leather having composite fibers and a method for making the same.

2. Description of the Related Art

An existing process for making an artificial leather includes an impregnation procedure of a substrate in an elastomer resin composition with a suitable solid content, a coating procedure and an elastomer hardening procedure, and then a cleaning procedure and a drying procedure to fabricate a semi-product. Next, a release paper transfer processing or embossing is performed on the semi-product, so as to obtain an artificial leather with natural texture; alternatively, grinding is performed on a surface of the flexible film, so as to obtain a suede artificial leather.

Another process for making an artificial leather includes the following steps. An elastic resin solution or latex is directly and uniformly coated onto a release paper, and then the elastic resin solution or latex is baked to remove the solvent to form a flexible film. The coating and baking steps may be repeated according to the different function or the thickness requirements to form a multi-layered flexible film. Finally, an elastic polymer adhesive is uniformly coated on a surface of the flexible film, the substrate is adhered to the flexible film and baked, such that the flexible film and the substrate are adhered fully, and the release paper is peeled off after cooling, so as to obtain an artificial leather.

The substrate strength of the artificial leather depends on the bonding force between the elastomer resin and the fiber and on the physical entanglement between fibers. As the strength requirement increases, it is required to provide a method to improve on the substrate strength.

Most of superfine fiber artificial leathers need to be subjected to a splitting process by means of a solvent or lye. As a solvent or lye is needed in the splitting processing, serious environmental pollution can be caused, which is not meeting the current trend of environmental protection.

Therefore, it is necessary to provide an innovative and inventive artificial leather having composite fibers and a method for making the same, so as to solve the above-noted problems.

### SUMMARY OF THE INVENTION

The present invention provides an artificial leather having composite fibers. The artificial leather includes a substrate and a flexible film. The substrate includes a plurality of composite fibers. Each composite fiber includes a first composition and a second composition. The first composition is a thermoplastic non-elastomer, and the second composition is a thermoplastic elastomer. The second composition accounts for 5% to 70% of the total weight of the composite fiber. The first and second compositions are alternately distributed on a circumference of a cross section of the composite fiber, and the second composition accounts for 50% or less of the total length of the circumference. The second composition at the intersecting points between the composite fibers is molten to form a flexible bonding point. The flexible film is located on a surface of the substrate, and the material of the flexible film is an elastic polymer or a latex.

The present invention further provides a method for making an artificial leather having composite fibers, which includes: (a) providing a substrate, in which the substrate includes a plurality of composite fibers, each composite fiber includes a first composition and a second composition, the first composition is a thermoplastic non-elastomer, the second composition is a thermoplastic elastomer; the second composition accounts for 5% to 70% of the total weight of the composite fiber, the first composition and the second composition are alternately distributed on a circumference of a cross section of the composite fiber, the second composition accounts for 50% or less of the total length of the circumference and the second composition at the intersecting points between the composite fibers is molten to form a flexible bonding point; and (b) forming a flexible film on a surface of the substrate, in which the material of the flexible film is an elastic polymer or a latex.

In the present invention, the thermoplastic elastomer in the composite fiber is uniformly dispersed and can improve the adhesion between fibers, and the splittable fiber cross section can further prevent influences on processing caused by over-adhesion of the thermoplastic elastomer during the production of the fiber and the non-woven fabric substrate, so the cloth surface can be more fine and more flat after the non-woven fabric is hot-pressed, so the physical properties are improved, and so a higher dimensional stability can be achieved. Furthermore, in the process of fiber micronization of the non-woven fabric substrate, no additional solvent is used, so the process is an environmental-friendly fiber opening process without waste being produced, and then the substrate is processed into an artificial leather having excellent textile feeling and physical properties.

### DETAILED DESCRIPTION OF THE INVENTION

According to the present invention, a first composition (a thermoplastic non-elastomer) and a second composition (a thermoplastic elastomer, TPE) are used for splittable superfine fiber composite spinning, so as to make a composite fiber, and then the composite fiber is further processed into creating an artificial leather substrate and an artificial leather. The composite fiber is characterized in that the first composition (the thermoplastic non-elastomer) accounts for 30% to 95%, and preferably 40% to 60%, of the total weight of the composite fiber; and the second composition (the thermoplastic elastomer) accounts for 5% to 70%, and preferably 40% to 60%, of the total weight of the composite fiber. The second composition (the thermoplastic elastomer) is non-continuously distributed on a circumference of a cross section of the composite fiber, is in an alternate manner with the first composition (the thermoplastic non-elastomer), and accounts for 50% or less of the total length of the circumference of the cross section of the composite fiber.

According to the present invention, the material of the first composition may be a polyester polymer, a polyamide polymer, or a polyolefin polymer. The polyester polymer is polyethylene terephthalate (PET), polybutylene terephthalate (PBT), polypropylene terephthalate (PTT), modified polymers or copolymers thereof. The polyamide polymer is polyamide 6 (PA6), polyamide 66 (PA66), polyamide 12 (PA12), modified polymers or copolymers thereof. The polyolefin polymer is polyethylene (PE), polypropylene (PP), modified polymers or copolymers thereof Additionally, a functional additive such as a dye, carbon black, a plasticizer, and a stabilizer may also be added, if preferred.

According to the present invention, the material of the second composition may be a thermoplastic styrenic block copolymer elastomer, a thermoplastic polyester elastomer (TPEE), a thermoplastic polyolefin elastomer (TPO), a thermoplastic polyolefin vulcanizate elastomer (TPV), or a thermoplastic polyamide elastomer (TPA). The thermoplastic styrenic block copolymer elastomer is a styrene-butadiene-styrene (SBS) thermoplastic elastomer, a styrene-ethylene/butylene-styrene (SEBS) thermoplastic elastomer, a styrene-ethylene/propylene-styrene (SEPS) thermoplastic elastomer, a styrene-isoprene-styrene (SIS) thermoplastic elastomer, or mixtures thereof The thermoplastic polyolefin (TPO) elastomer is a thermoplastic ethylene-propylene (TEP) copolymer elastomer. Additionally, a functional additive such as a dye, carbon black, a plasticizer, and a stabilizer may also be added, if preferred.

The present invention provides a substrate of an artificial leather. The substrate includes a plurality of composite fibers (the aforementioned composite fibers). Each composite fiber includes a first composition (the aforementioned first composition) and a second composition (the aforementioned second composition). The first composition is a thermoplastic non-elastomer, and the second composition is a thermoplastic elastomer. The second composition accounts for 5% to 70%, and preferably 40% to 60%, of the total weight of the composite fiber. The first composition and the second composition are alternately distributed on a circumference of a cross section of the composite fiber, and the second composition accounts for 50% or less of the total length of the circumference. The second composition at the intersecting points between the composite fibers is molted to form a flexible bonding point.

Preferably, the substrate further includes a plurality of mixed fibers, and the mixed fibers are thermoplastic non-elastomers, with its material being selected from the group consisting of a polyester polymer, a polyamide polymer, and a polyolefin polymer. The composite fibers account for 5% to 75% of the total weight of the substrate.

The composite fibers form a plurality of first fiber webs, and the mixed fibers form a plurality of second fiber webs, where the first fiber webs and the second fiber webs are stacked on each other; alternatively, the mixed fibers and the composite fibers are mixed to form a plurality of third fiber webs, and the third fiber webs are stacked on each other. The second composition at the intersecting points between the mixed fibers and the composite fibers is molten to form a flexible bonding point.

Hereinafter, a method for making a non-woven fabric substrate is described with reference to an embodiment. First, the composite fibers are processed into a plurality of fiber webs through a spunbonding method, melt blowing method, carding method, wet method, and air laying method, and then multiple fiber webs are stacked, in which the fiber component and proportion of different fiber webs may be different. Next, fibers are entangled through needle punching (or water jet punching) to be turned into non-woven fabric with a base weight of 100 g/m² to 1000 g/m², and the non-woven fabric is then subjected to hot pressing at 80° C.-200° C. to iron the surface of the non-woven fabric, so as to melt the second composition and thus to bond the composite fibers. Finally, the second composition is hardened, such that the second composition at the intersecting points between the composite fibers is molten to form a flexible bonding point, and thus to obtain the non-woven fabric substrate for an artificial leather.

The present invention further provides an artificial leather, which includes a substrate (the aforementioned substrate) and a flexible film. The substrate is a non-woven fabric substrate. The flexible film is located on a surface of the substrate, and the material of the flexible film is, for example, an elastic resin, an elastic polymer and a latex. Preferably, the artificial leather further includes an internal elastic resin, uniformly filled in the substrate, and the material of the internal elastic resin is an elastic polymer or a latex. The material of the flexible film and the material of the internal elastic resin may be the same or may be different.

The method for making the artificial leather includes, but is not limited to, the following five methods:

First method: The non-woven fabric substrate is impregnated in an elastic resin solution (for example, an elastic polymer solution or a latex). The substrate is extruded to maintain the absorption of the elastic resin solution at a desired proportion, and then a solvent within the solution is removed to coagulate the elastic resin solution, so as to form an internal elastic resin. Then, an elastic resin solution is coated, and then a solvent within the solution is removed to coagulate the elastic resin solution. Thereafter, the residual solvent is removed by water washing and the moisture is removed in sequence to obtain a semi-product, and at this time, the coagulated elastic resin forms a flexible film. Next, release paper transfer processing or embossing is further performed on the semi-product, to obtain an artificial leather with natural texture; alternatively, grinding is performed on the surface of the flexible film, to obtain a suede artificial leather.

Second method: The non-woven fabric substrate is impregnated in an elastic resin solution (for example, an elastic polymer solution or a latex). The substrate is extruded to maintain the absorption of the elastic resin solution at a desired proportion. After the solvent within the solution is slightly removed, an elastic resin solution is coated on a surface of the substrate, and then a solvent within the solution is removed to coagulate the elastic resin solution. The residual solvent is removed by water washing and the moisture is removed in sequence to obtain a semi-product, and at this time, the elastic resin filled in the substrate forms an internal elastic resin, and the elastic resin located at the surface forms a flexible film. Next, release paper transfer processing or embossing is further performed on the semi-product, to obtain an artificial leather with natural texture; alternatively, grinding is performed on the surface of the flexible film, to obtain a suede artificial leather.

Third method: An elastic resin solution (for example, an elastic polymer solution or a latex) is directly and uniformly coated on the non-woven fabric substrate, and then a solvent within the solution is removed to coagulate the elastic resin solution. The residual solvent is removed by water washing and the moisture is removed in sequence to obtain a semi-product, and at this time, the coagulated elastic resin solution forms a flexible film. Next, release paper transfer processing or embossing is further performed on the semi-product, to obtain an artificial leather with natural texture; alternatively, grinding is performed on the surface of the flexible film, to obtain a suede artificial leather.

Fourth method: The non-woven fabric substrate is impregnated in an elastic resin solution (for example, an elastic polymer solution or a latex). The substrate is extruded to maintain the absorption of the elastic resin solution at a desired proportion, and a solvent within the solution is removed to coagulate the elastic resin solution. The residual solvent is removed by water washing and the moisture is removed in sequence to obtain a semi-product, and at this time, the elastic resin filled in the substrate forms an internal elastic resin, and the elastic resin located at the surface forms a flexible film. Next, release paper transfer processing or embossing is further performed on the semi-product, to obtain an artificial leather with natural texture; alternatively, grinding is performed on the surface of the flexible film, to obtain a suede artificial leather.

Fifth method: An elastic resin solution (for example, an elastic polymer solution or a latex) is directly and uniformly coated on a carrier (release paper), and the elastic resin solution forms a flexible film after the solvent within the solution is removed by baking. The coating and baking steps may be repeated depending on different function or thickness demanded to form a multi-layered flexible film. Finally, an elastic polymer adhesive is uniformly coated on a surface of the flexible film, and then the non-woven fabric substrate is adhered and baked, such that the flexible film and the non-woven fabric substrate are fully adhered together. After cooling, the carrier (release paper) is peeled off to obtain an artificial leather.

When an impregnated elastic resin (for example, an elastic polymer or a latex) is coagulated and filled in the substrate (the internal elastic resin), the elastic resin and the fibers in the substrate are bonded at the flexible bonding points within the substrate, such that the artificial leather has excellent textile sensation and physical properties.

The material of the elastic resin for forming the flexible film and the internal elastic resin may be a synthetic resin such as polyvinyl chloride, polyamide, polyester, polyester-ether copolymer, polyacrylate copolymer, polyurethane, neoprene, styrene-butadiene copolymer, silicone, polyamino acid, and polyamino acid-polyurethane copolymer, a natural polymer resin, and mixtures thereof Additionally, a pigment, a dye, a cross-linking agent, a filling agent, a plasticizer, and a stabilizer may also be added, if preferred.

The present invention has the following advantages. The thermoplastic elastomer in the composite fiber is uniformly dispersed and can improve the adhesion between fibers, and the splittable fiber cross section can further prevent influences on processing caused by over-adhesion of the thermoplastic elastomer during the production of the fiber and the non-woven fabric substrate, so the cloth surface is fine and flat after the non-woven fabric is hot-pressed, so the physical properties are improved, and so a higher dimensional stability can be achieved. Furthermore, in the process of fiber micronization of the non-woven fabric substrate, no additional solvent is used, so the process is an environmental friendly fiber opening process without waste being produced. Moreover, the non-woven fabric substrate has the textile sensation of a superfine fiber and a rebound touch that is similar to that of natural leather, and then the substrate is processed into an artificial leather having excellent textile sensation and physical properties.

Examples are given below to illustrate the present invention, but the present invention is not limited thereto.

### EXAMPLE 1

First, composite staple cotton (from San Fang Chemical Industry Co., Ltd.) is provided. Within the composite staple cotton, a weight ratio of SEBS thermoplastic elastomer to polybutylene terephthalate (PBT) is 40/60. Next, 6-denier composite staple cotton and 2-denier polyester staple cotton (the material of which is polyethylene terephthalate (PET), from San Fang Chemical Industry Co., Ltd.) are mixed at a ratio of 30/70, and then are opened and carded to make fiber webs. 5 fiber webs are stacked, and then roughing and finishing processes are performed in sequence to produce physical entanglement of fibers, so as to make a non-woven fabric having a weight per unit area of 260 g/m². The non-woven fabric is then hot pressed at 160° C. to make the surface smooth, and at this time, SEBS is molten, such that the fibers can be opened and partially adhered during the process of hot pressing and cooling, so as to make a substrate of an artificial leather. As the thermoplastic elastomer is dispersed and adhered between the fibers, the substrate of an artificial leather has good performance, and has some of the textile sensation of an artificial leather when being kneaded.

### COMPARATIVE EXAMPLE 1

100% polyester staple cotton (a PET material, from San Fang Chemical Industry Co., Ltd.) is opened and carded to make fiber webs; under the same conditions as in Example 1, roughing and finishing processes is performed in sequence to produce physical entanglement of fibers, so as to make a non-woven fabric having a weight per unit area of 260 g/m². The non-woven fabric is then hot pressed at 190° C. to make the surface smooth.

Referring to Table 1, a comparison of physical properties of the substrate of the Comparative Example 1 (100% polyester staple cotton) and the substrate of the Example 1 (30% SEBS composite staple cotton +70% polyester staple cotton) is shown. As shown in Table 1, the substrate with SEBS thermoplastic elastomer/PBT composite staple cotton added has significantly improved tear strength, tensile strength, peel strength and burst strength, and has decreased elongation which is beneficial to the dimensional stability of the substrate during processing.

TABLE 1
Comparison of physical properties of the substrate of the
Comparative Example 1 (100% polyester staple cotton) and
the substrate of the Example 1 (30% SEBS composite staple
cotton + 70% polyester staple cotton) (in which MD is
the mechanical direction, and CD is the cross direction.)

| Fiber Composition of | | Tear | Tensile | Elonga- | Peel | Burst |
|---|---|---|---|---|---|---|
| Non-woven Fabric | | Strength | Strength | tion | Strength | Strength |
| Substrate | | (kg) | (kg) | (%) | (kg) | (kg) |
| 100% Polyester | MD | 8.5 | 24 | 80 | 12 | 15 |
| Staple Cotton | CD | 7.0 | 26 | 90 | | |
| 30% Styrene- | MD | 10 | 32 | 65 | 17 | 20 |
| Ethylene/ | CD | 8 | 29 | 76 | | |
| Butylene-Styrene | | | | | | |
| (SEBS) | | | | | | |
| Composite | | | | | | |
| Staple Cotton + | | | | | | |
| 70% Polyester | | | | | | |
| Staple Cotton | | | | | | |

### EXAMPLE 2

The substrate of an artificial leather made in Example 1 is passed through a mixture of dimethylformamide (DMF) and water (having a concentration of 25-35 wt %), extruded by a rolling wheel to remove excessive liquid, coated with a solution of elastic polyurethane (from San Fang Chemical Industry Co., Ltd.) in DMF (solid content 25%) to a thickness of 1.0 mm, and then placed in water to remove the solvent DMF, such that polyurethane is coagulated to form a flexible film of micro-porous elastic resin. Then, the substrate is washed with water at a high temperature to remove the solvent completely and dried, to obtain an artificial leather semi-product having excellent physical properties, which is then subjected to release paper transfer processing, to obtain an artificial leather with natural texture.

### COMPARATIVE EXAMPLE 2

The substrate of an artificial leather made in Comparative Example 1 is passed through a mixture of DMF and water (having a concentration of 25-35 wt %), extruded by a rolling wheel to remove excessive liquid, coated with a solution of elastic polyurethane (from San Fang Chemical Industry Co., Ltd.) in DMF (solid content 25%) to a thickness of 1.0 mm, and then placed in water to remove the solvent DMF, such that polyurethane is coagulated to form a flexible film of micro-porous elastic resin. Then, the substrate is washed with water at a high temperature to remove the solvent completely and dried, to obtain an artificial leather semi-product having excellent physical properties, which is then subjected to release paper transfer processing, to obtain an artificial leather with natural texture.

Referring to Table 2, a comparison of physical properties of the artificial leather (100% polyester staple cotton) of the Comparative Example 2 and the artificial leather (30% SEBS composite staple cotton +70% polyester staple cotton) of the Example 2 is shown. As shown in Table 2, the artificial leather with SEBS thermoplastic elastomer/PBT composite staple cotton added has significantly improved tear strength, tensile strength, peel strength and burst strength, and has superfine textile sensation.

TABLE 2
Comparison of physical properties of the artificial leather
(100% polyester staple cotton) of the Comparative Example 2
and the artificial leather (30% SEBS composite staple cotton +
70% polyester staple cotton) of the Example 2 (in which
MD is the mechanical direction, and CD is the cross direction.)

| Fiber Composition of | | Tear | Tensile | Elonga- | Peel | Burst |
|---|---|---|---|---|---|---|
| Non-woven Fabric | | Strength | Strength | tion | Strength | Strength |
| Substrate | | (kg) | (kg) | (%) | (kg) | (kg) |
| 100% Polyester | MD | 8.8 | 41 | 72 | 3.6 | 24 |
| Staple Cotton | CD | 7.2 | 33 | 86 | | |
| 30% SEBS | MD | 10.2 | 42.3 | 64 | 4.5 | 26 |
| Composite | CD | 9.5 | 38.5 | 86 | | |
| Staple Cotton + | | | | | | |
| 70% Polyester | | | | | | |
| Staple Cotton | | | | | | |

A comparison of dimensional variation is shown in Table 3, which shows that the artificial leather (30% SEBS composite staple cotton +70% polyester staple cotton) of the Example 2 has better dimensional stability than the artificial leather (100% polyester staple cotton) of the Comparative Example 2, after being subject to 30 minutes at 120° C.

TABLE 3
Dimensional variations of the artificial leather (100%
polyester staple cotton) of the Comparative Example 2
and the artificial leather (30% SEBS composite staple
cotton + 70% polyester staple cotton) of the Example 2

| | | | Example 2 | |
|---|---|---|---|---|
| | Comparative Example 2 | | Artificial Leather of 30% SEBS | |
| | Artificial Leather of 100% | | Composite Staple Cotton + 70% | |
| | Polyester Staple Cotton | | Polyester Staple Cotton | |
| | MD | CD | MD | CD |
| Before | 100.07 | 100.10 | 100.03 | 100.05 |
| baking | | | | |
| After | 99.04 | 98.52 | 99.13 | 99.20 |
| baking | | | | |
| Shrinkage | 1.03% | 1.58% | 0.90% | 0.85% |

### EXAMPLE 3

First, composite staple cotton (from San Fang Chemical Industry Co., Ltd.) is provided. Within the composite staple cotton, the weight ratio of SEBS thermoplastic elastomer pellet (manufactured by Kraton Polymers LLC Company) to PET is 40/60. Next, 4-denier composite staple cotton, 3-denier polyester staple cotton (the material of which is PET, from San Fang Chemical Industry Co., Ltd.), and 3-denier nylon staple fiber (manufactured by San Fang Chemical Industry Co., Ltd.) are mixed at a weight ratio of 30/40/30, and then are opened and carded to make fiber webs. Five fiber webs are stacked, and then roughing and finishing processes are performed in sequence to produce physical entanglement of fibers, so as to make a non-woven fabric having a weight per unit area of 220 g/m². The non-woven fabric is then hot pressed at 160° C. to make the surface smooth, and at this time, SEB S is molten, such that the fibers are opened and partially adhered to a thickness of 0.7 mm during the process of hot pressing and cooling, so as to make an substrate of an artificial leather. As the thermoplastic elastomer is dispersed and adhered between the fibers, the substrate of an artificial leather has good performance, and has some of the textile sensation of an artificial leather when being kneaded.

The substrate is impregnated in an elastic resin solution having a solid content of 9%, in which the elastic resin absorption is controlled by using a rolling wheel, and then the substrate is passed through a mixture of DMF and water (having a concentration of 25-30 wt %), extruded by a rolling wheel to remove excessive liquid, coated with a solution of elastic polyurethane (from San Fang Chemical Industry Co., Ltd.) in DMF (solid content 25%) to a thickness of 1.1 mm, and then placed in water to remove the solvent DMF, such that polyurethane is coagulated to form a flexible film of micro-porous elastic resin. Then, the substrate is washed with water at a high temperature to remove the solvent completely and dried, to obtain an artificial leather semi-product having excellent physical properties, which is then subjected to release paper transfer processing, to obtain an artificial leather with natural texture.

### EXAMPLE 4

The substrate of an artificial leather made in Example 3 is impregnated in an aqueous elastic resin (aqueous polyurethane, from Nicca Chemical Co., Ltd.) having a solid content of 25%, and the elastic resin absorption (320%) is controlled by using an rolling wheel; then moisture is removed by using a high-temperature oven, to coagulate the elastic resin and to obtain an artificial leather semi-product having excellent physical properties, which is then subjected to release paper transfer processing, to obtain an artificial leather with natural texture.

While several embodiments of the present invention have been illustrated and described, various modifications and improvements can be made by those skilled in the art. The embodiments of the present invention are therefore described in an illustrative but not restrictive sense. It is intended that the present invention should not be limited to the particular forms as illustrated, and that all modifications which maintain the spirit and scope of the present invention are within the scope defined in the appended claims.

What is claimed is:

1. An artificial leather having composite fibers, comprising:
a substrate, comprising a plurality of composite fibers, wherein each composite fiber comprises a first composition and a second composition, the first composition is a thermoplastic non-elastomer, the second composition is a thermoplastic elastomer (TPE), the second composition accounts for 5% to 70% of the total weight of the composite fiber, the first composition and the second composition are alternately distributed on a circumference of a cross section of the composite fiber, the second composition accounts for 50% or less of the total length of the circumference, and the second composition at the intersecting points between the composite fibers is molten to form a flexible bonding point; and
a flexible film, located on a surface of the substrate, wherein the material of the flexible film is an elastic polymer or a latex.

2. The artificial leather according to claim 1, wherein the substrate further comprises a plurality of mixed fibers, the mixed fibers are thermoplastic non-elastomers, and the second composition at the intersecting points between the mixed fibers and the composite fibers is molten to form a flexible bonding point.

3. The artificial leather according to claim 1, wherein the material of the first composition is selected from the group consisting of a polyester polymer, a polyamide polymer, and a polyolefin polymer; the material of the second composition is selected from the group consisting of a thermoplastic styrenic block copolymer elastomer, a thermoplastic polyester elastomer (TPEE), a thermoplastic polyolefin elastomer (TPO), a thermoplastic polyolefin vulcanizate elastomer (TPV) and a thermoplastic polyamide elastomer (TPA); and the material of the flexible film is an elastic polymer selected from the group consisting of polyvinyl chloride, polyamide, polyester, polyester-ether copolymer, polyacrylate copolymer, polyurethane, neoprene, styrene-butadiene copolymer, silicone, polyamino acid, polyamino acid-polyurethane copolymer, a natural polymer resin, and mixtures thereof.

4. The artificial leather according to claim 1, further comprising an internal elastic resin, uniformly filled in the substrate, wherein the material of the internal elastic resin is a synthetic resin comprising polyvinyl chloride, polyamide, polyester, polyester-ether copolymer, polyacrylate copolymer, polyurethane, neoprene, styrene-butadiene copolymer, silicone, polyamino acid, polyamino acid-polyurethane copolymer, a natural polymer resin, or mixtures thereof.

5. A method for making an artificial leather having composite fibers, comprising:
(a) providing a substrate, wherein the substrate comprises a plurality of composite fibers, each composite fiber comprises a first composition and a second composition, the first composition is a thermoplastic non-elastomer, the second composition is a thermoplastic elastomer (TPE), the second composition accounts for 5% to 70% of the total weight of the composite fiber, the first composition and the second composition are alternately distributed on a circumference of a cross section of the composite fiber, the second composition accounts for 50% or less of the total length of the circumference, and the second composition at the intersecting points between the composite fibers is molten to form a flexible bonding point; and
(b) forming a flexible film on a surface of the substrate, wherein the material of the flexible film is an elastic polymer or a latex.

6. The making method according to claim 5, wherein the substrate in Step (a) further comprises a plurality of mixed fibers, the mixed fibers are thermoplastic non-elastomers, and the second composition at the intersecting points between the mixed fibers and the composite fibers is molten to form a flexible bonding point.

7. The making method according to claim 6, wherein the material of the mixed fibers is selected from the group consisting of a polyester polymer, a polyamide polymer, and a polyolefin polymer; the material of the first composition is selected from the group consisting of a polyester polymer, a polyamide polymer, and a polyolefin polymer; the material of the second composition is selected from the group consisting of a thermoplastic styrenic block copolymer elastomer, a thermoplastic polyester elastomer (TPEE), a thermoplastic polyolefin elastomer (TPO), a thermoplastic polyolefin vulcanizate elastomer (TPV) and a thermoplastic polyamide elastomer (TPA); and the material of the flexible film is an elastic polymer selected from the group consisting of polyvinyl chloride, polyamide, polyester, polyester-ether copolymer, polyacrylate copolymer, polyurethane, neoprene, styrene-butadiene copolymer, silicone, polyamino acid, polyamino acid-polyurethane copolymer, a natural polymer resin, and mixtures thereof.

8. The making method according to claim 5, wherein a method for making the substrate in Step (a) comprises:
(a1) providing a plurality of composite fibers, wherein each composite fiber comprises a first composition and a second composition, the first composition is a thermoplastic non-elastomer the second composition is a thermoplastic elastomer (TPE), the second composition accounts for 5% to 70% of the total weight of the composite fiber, the first composition and the second composition are alternately distributed on a circumference of a cross section of the composite fiber, and the second composition accounts for 50% or less of the total length of the circumference;
(a2) forming a plurality of fiber webs, wherein the fiber webs comprise the composite fibers;
(a3) stacking the fiber webs;
(a4) needle punching or water jet punching the fiber webs;
(a5) melting the second composition, so as to bond the composite fibers; and
(a6) hardening the second composition, such that the second composition at the intersecting points between the composite fibers forms a flexible bonding point.

9. The making method according to claim 5, wherein the material of the first composition is selected from the group consisting of a polyester polymer, a polyamide polymer, and a polyolefin polymer, and the material of the second composition is selected from the group consisting of a thermoplastic styrenic block copolymer elastomer, a thermoplastic polyester elastomer (TPEE), a thermoplastic polyolefin elastomer (TPO), thermoplastic polyolefin vulcanizate elastomer (TPV) and a thermoplastic polyamide elastomer (TPA).

10. The making method according to claim 5, wherein Step (b) comprises:
(b1) directly coating an elastic resin solution on the substrate;
(b2) removing a solvent to coagulate the elastic resin solution;
(b3) removing the solvent by water washing and removing the moisture, so as to form the flexible film; and
(b4) processing a surface of the flexible film, so as to obtain an artificial leather.

11. The making method according to claim 5, wherein Step (b) comprises:
(b1) impregnating the substrate in an elastic resin solution, such that the elastic resin solution penetrates into the substrate;
(b2) extruding the substrate to maintain the absorption of the elastic resin solution at a desired proportion;
(b3) coating an additional elastic resin solution on a surface;
(b4) removing a solvent to coagulate the elastic resin solution;
(b5) removing the solvent by water washing and removing the moisture, wherein the elastic resin filled in the substrate forms an internal elastic resin, and the elastic resin located at the surface of the substrate forms the flexible film; and
(b6) processing a surface of the flexible film, to obtain an artificial leather.
